(19) United States
(12) Patent Application Publication
(10) Pub. No.: US 2007/0183683 A1
(43) Pub. Date: Aug. 9, 2007

(54) Blurring an image using a graphic processing unit

(75) Inventors: Douglas A. Ricard, Woodinville, WA (US); Denis C. Demandolx, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/348,058

(22) Filed: Feb. 6, 2006

(51) Int. Cl. G06K 9/40

(52) U.S. Cl. 382/264

(57) ABSTRACT

A method is provided for applying a blur to an image using a graphic processing unit (“GPU”). The method includes instructing the GPU to scale an image down from an original size; instructing the GPU to blur the scaled down image; and instructing the GPU to return the blurred image to the original size.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND

A blur is a common filter used to change the appearance of an image or part of an image. A Gaussian blur is a convolution filter (i.e. linear filter). An output signal is computed by convolving an entering signal and a response of a filter to a delta impulse. The response of the filter to the delta impulse is also known as a point spread function (“PSF”). In a Gaussian blur, the PSF is a Gaussian distribution (i.e. a bell-shape curve). During the convolution operation, each output pixel is calculated as the weighted average of neighboring input pixels. The Gaussian distribution ensures that a blur weights closer pixels more than pixels that are further away. In theory, the Gaussian distribution is infinite but tends towards zero rapidly; therefore, the numerical implementation of the convolution algorithm truncates the distribution where weighting coefficients are very close to zero. This is known as using a finite impulse response (“FIR”). It is commonly accepted that the quality of a Gaussian blur is sufficient when the actual width of the convolution window/kernel is set to 6 times the standard deviation of the Gaussian distribution.

A Gaussian blur smoothes sharp details in an image and is known as a low-pass filter. “Low-pass” is a signal processing term to qualify a filter that blurs a signal, in other words, a transformation that filters out high-frequencies and keeps low-frequencies. In contrast, high-pass filters sharpen edges in an image and therefore are not compatible with the scale-down idea that actually blurs the image.

Among convolution filters, a Gaussian blur is decomposable. Instead of convolving the image with a two dimensional Gaussian distribution and computing W×W (where “W” is the width of a Gaussian window/kernel) weighting multiplications and additions for each output pixel, the filter is decomposable into two one dimensional passes where only 2×W weighting multiplications and additions for each output pixel is needed. Even with this enhancement, a Gaussian blur window/kernel can be large with a filter that is computationally intensive. And while this method produces a very high quality blur, it also requires more time to render than a basic blur filter. The number of pixels that are to be averaged when performing a Gaussian blur is proportional to the radius, more particularly, the standard deviation of the Gaussian distribution; therefore, the amount of time required to perform a Gaussian blur increases as the radius increases.

This is especially apparent when trying to highlight the foreground of an image by blurring out the background. In these cases, a radius of more than 100 pixels is not unusual, which is 100 times as slow a one pixel-radius blur. One solution to this problem is scaling an image down to a smaller size, applying the blur to the scaled down image and returning the image to the original size. Utilizing algorithms that scale an image down and back up after a blur is performed is significantly faster than simply applying a Gaussian blur. A downscaling algorithm provides a low-pass filtering and the composition of a downscale/Gaussian blur/upscale gives an acceptable approximation of the original full-size Gaussian blur. To accomplish this, the radius needed to be applied is R/S where “R” is the radius and “S” is the scaling. For example, scaling each dimension by ¼ applies ¼ the radius over 1/16 as many pixels. The scaling is determined in a quality/performance case to keep the quality difference small and the downscaling factor (as a low-pass factor) should be chosen in accordance with the band-width of the original blur convolution filter.

In a standard Gaussian blur, a table of Gaussian blur weights is recalculated whenever the radius is changed, therefore, a lot of work is done on each adjustment of the radius. One way to overcome recalculating weights is to have a predetermined radius. FIG. 7 is a graph illustrating a comparison of a normal Gaussian blur and an interpolated Gaussian blur. The x-axis represents a pixel radius and the y-axis represents the amount of pixels at that radius that is applied (i.e. the weighting coefficient). For example, in current software implementations, x represents a zero radius, the difference between interpolated Gaussian blur 702 and standard Gaussian blur 704 is virtually indistinguishable when the blur radius is kept at or above 5 pixels.

Currently, computation of a Gaussian blur utilizing the scaling feature is performed solely through software on a central processing unit (“CPU”). The software contains code that is designed to scale an image down, code that is designed to perform a blur, and code that is designed to return the image to original size. The codes, as they exist today, are run one after the other and are very time consuming when implemented on the CPU by software.

### BRIEF SUMMARY

The deficiencies described above are overcome by providing a method for applying a blur using a graphic processing unit (“GPU”). By taking advantage of the speed and ability the GPU has to offer, the present invention allows a user to perform a blur very quickly without losing a significant amount of quality.

In an embodiment, a method is provided for applying a blur to an image using a GPU. The method comprises instructing the GPU to scale the image down from an original size and instructing the GPU to blur the scaled down image. The method further comprises instructing the GPU to return the blurred image to the original size.

In another embodiment, a method is provided for applying a blur to an image using a GPU. The method comprises instructing the GPU to scale the image down from an original size and instructing the GPU to blur the scaled down image. The method further comprises blurring the scaled down image according to a predetermined radius that is related to a pixel and instructing the GPU to return the blurred scaled down image to the original size.

In yet another embodiment, a method is provided for applying a Gaussian blur to an image using a GPU. The method comprises instructing the GPU to scale the image down from an original size using a GPU's vertex shader module and blurring the scaled down image using a pixel shader module. The method further comprises blurring the scaled down image according to a predetermined radius that is related to a pixel and instructing the GPU to return the scaled down image to the original size using the vertex shader module. Finally, the method further comprises presenting the image to a user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary computing environment suitable for use in an embodiment of the present invention;

FIG. 2 is a diagram illustrating a blur of an image in an embodiment of the present invention;

FIG. 3 is a block diagram illustrating a software application instructing a graphic processing unit in an embodiment of the present invention;

FIG. 4 is a block diagram illustrating a graphic processing unit in an embodiment of the present invention;

FIG. 5 is a flow chart illustrating a method for applying a blur to an image in an embodiment of the present invention;

FIG. 6 is a flow chart illustrating a method for applying a blur to an image in an embodiment of the present invention; and

FIG. 7 is a graph illustrating a comparison of a pure Gaussian blur and an interpolated Gaussian blur in an embodiment of the present invention.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the specific features are described in detail below with reference to the attached drawing figures, which are incorporated in their entirety by reference herein.

The present invention provides an improved method for the presentation of items on a computer. An exemplary operating environment for the present invention is described below.

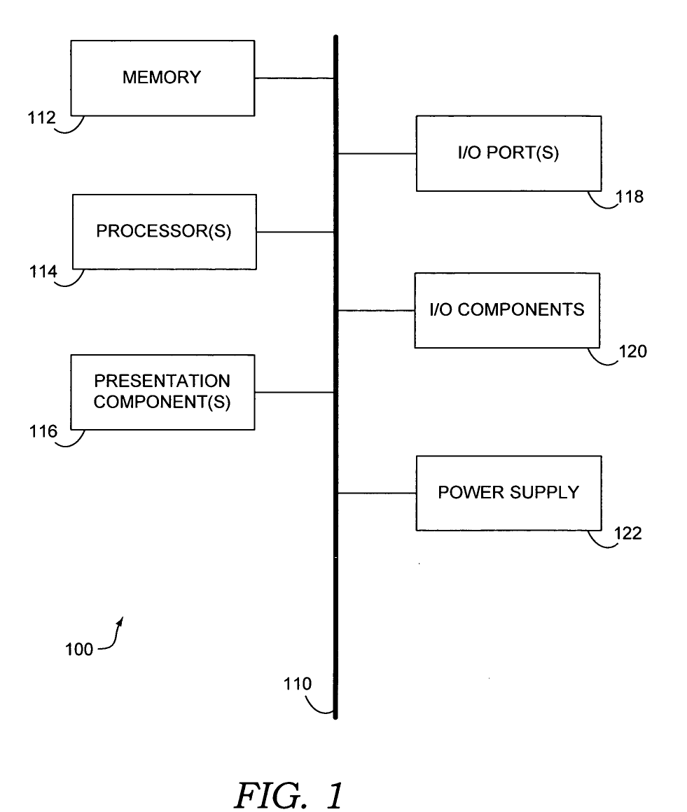

FIG. 1 is a block diagram illustrating an exemplary computing environment suitable for use in an embodiment of the present invention. Referring to FIG. 1, computing device 100 is illustrated. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, in an embodiment, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously mentioned, the current invention relates to an improved interface for the presentation of items on a computer. An item may be any piece of content displayable to a user or any piece of content having a graphical representation that may be displayed to a user. For example, an item may be a digital image, a grouping of letters or symbols (e.g., a word) or a file having an associated icon or thumbnail views.

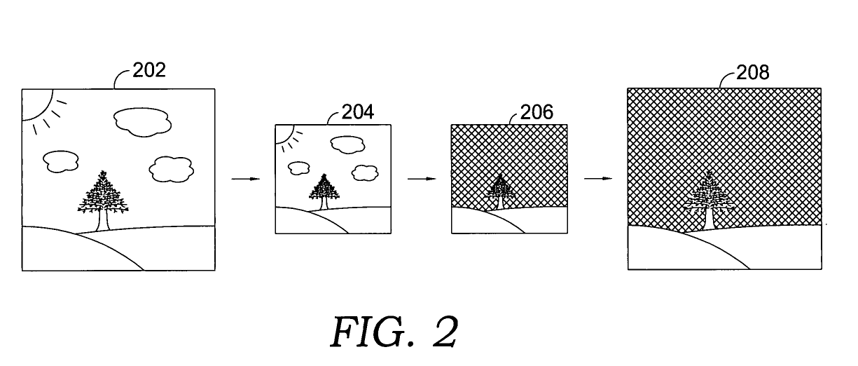

FIG. 2 is a diagram illustrating a blur of an image in an embodiment of the present invention. FIG. 2 illustrates original size image 202, scaled down image 204, scaled down blurred image 206, and original size blurred image 208. A graphic processing unit (“GPU”) is instructed to scale down original size image 202 to create scaled down image 204. The GPU is instructed to blur scaled down image 204 to create scaled down blurred image 206. The GPU is instructed to resize scaled down blurred image 206 to its original size, creating original size blurred image 208. Utilizing the GPU to apply an interpolation makes using the interpolation much more reasonable because the GPU does the interpolation so efficiently. The quality depends on the downscaling that has a low-pass filtering effect. In an embodiment, the GPU supports MipMapping. A MipMap, which is well known to one with ordinary skill in the art to have a low-pass filtering effect, is a collection of images, each down sampled one level further than the previous one. There is some overhead for the GPU to generate a MipMap, but once the GPU has the MipMap, the MipMap can be re-used for each blur.

Currently, an interpolation is applied to an image only utilizing a CPU. Software supplies code to the CPU that is designed to scale an image down, code that is designed to perform a blur, and code that is designed to return the image to its original size. The software implementation that is well known in the art is very time consuming. The concept behind utilizing a GPU in embodiments of the present invention is to take full advantage of the inherent strengths of the GPU. Scaling is an inherent capability of the GPU, therefore, the GPU is very good at rescaling images. Performing operations on pixels is also an inherent capability of the GPU; therefore, the GPU is very good at tasks such as blurring an image. A GPU is not the same as a CPU. Unlike the software code used for scaling images with the CPU, in an embodiment, virtually no software code is required for scaling images using the GPU. Software supplies code to the GPU instructing the GPU to scale a certain image by a certain factor and the GPU will perform the scaling very quickly. What took the CPU to do in 2-3 seconds, the GPU will do in much less time, e.g., tenths of a second. While GPUs are well known in the art, the usage thereof in embodiments of the present invention is novel.

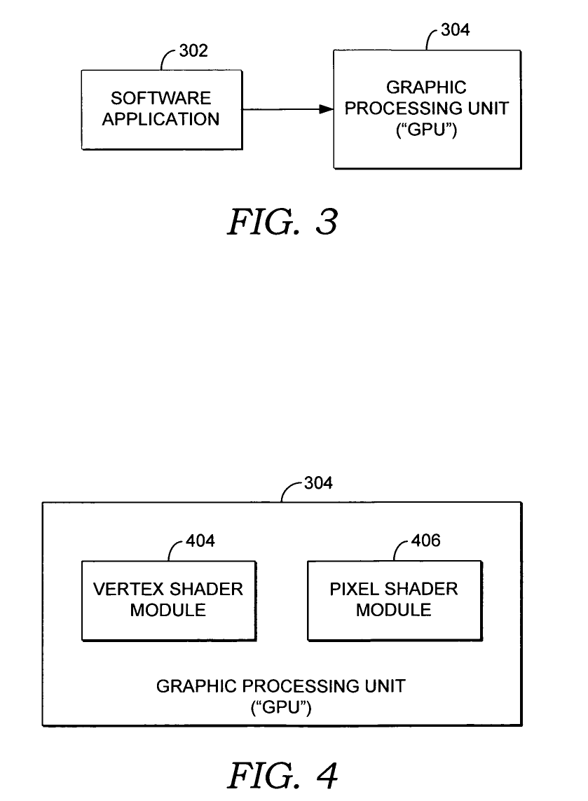

FIG. 3 is a block diagram illustrating a software application instructing a graphic processing unit in an embodiment of the present invention. FIG. 3 illustrates software application 302 and GPU 304. In an embodiment, software application 302 is any software code that provides instructions to GPU 304 to blur an image. In various embodiments, software application 302 may or may not be an executable, and may or may not form multiple blocks of code. Embodiments are not limited to any particular programming language or style. In an embodiment, GPU 304 is a specialized logic chip devoted to rendering images that are comprised of pixels. One with ordinary skill in the art will appreciate that pixels are generally the smallest addressable unit on a display unit or bitmapped image. In fact, display screens are rated by their number of horizontal and vertical pixels; for example, 1024×768 means 1024 pixels are displayed in each row, and there are 768 rows (lines). Likewise, bitmapped images are sized in pixels: a 350×250 image has 350 pixels across and 250 down. It will also be known with one ordinary skilled in the art that a GPU has a unit for manipulating geometry, the vertex shader, and a unit for manipulating pixels, a pixel shader.

FIG. 4 is a block diagram illustrating a graphic processing unit in an embodiment of the present invention. With reference to FIG. 4, in an embodiment, GPU 304 comprises vertex shader module 404 and pixel shader module 406. One with ordinary skill in the art will recognize that vertex shader module 404 and pixel shader module 406 are both common units in GPUs. In an embodiment, vertex shader module 404 is designed for location scaling along with the subsequent rasterization; therefore, the process of scaling an image down is performed with great quality and efficiency. In an embodiment, pixel shader module 406 is designed for changing the individual dots within a pixel; therefore, because GPU 304 comprises modules that are well adapted to blurring images, the process of blurring an image is performed with great quality and efficiency. In an embodiment, the radius of a blur is measured in pixels. In an embodiment, the blur performed is a Gaussian blur. In an embodiment, any low pass filter is applied. In an embodiment, the blur is performed using a predetermined radius of 5 pixels. However, embodiments of the present invention can be performed using any pixel radius. For example, a radius of greater than 5 pixels may be used. Also, a radius of less than 5 pixels may be used, e.g., 4 pixels.

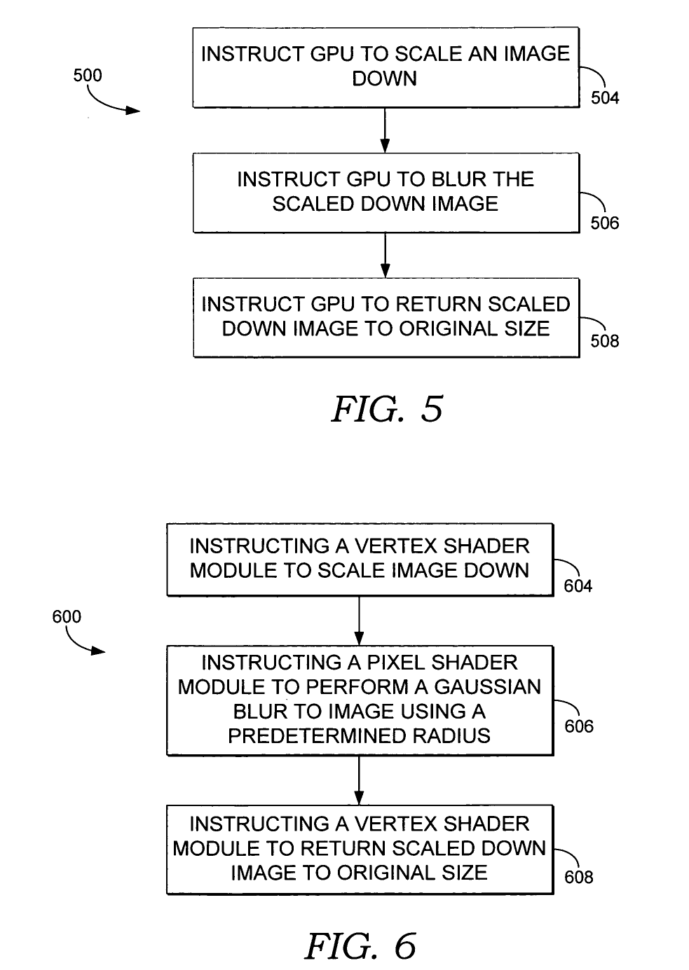

FIG. 5 is a flow chart illustrating a method for applying a blur to an image in an embodiment of the present invention. As illustrated in FIG. 5, method 500 begins at operation 504, where a GPU is instructed to scale an image down. At operation 506, the GPU is instructed to blur the scaled down image. At operation 508, the GPU is instructed to return the scaled down image to its original size. In an embodiment, the original image is received from a user, and in an embodiment, the blurred original size image is presented to the user. However, embodiments of the present invention are not so limited, as images may be obtained from any source, and presented in any number of ways. In an embodiment, the original size of the image is established and the portion of the image to be blurred is automatically determined. In another embodiment, the portion of the image to be blurred is pre-selected by the user. In still another embodiment the user is prompted to select the portion of the image the user wishes to blur.

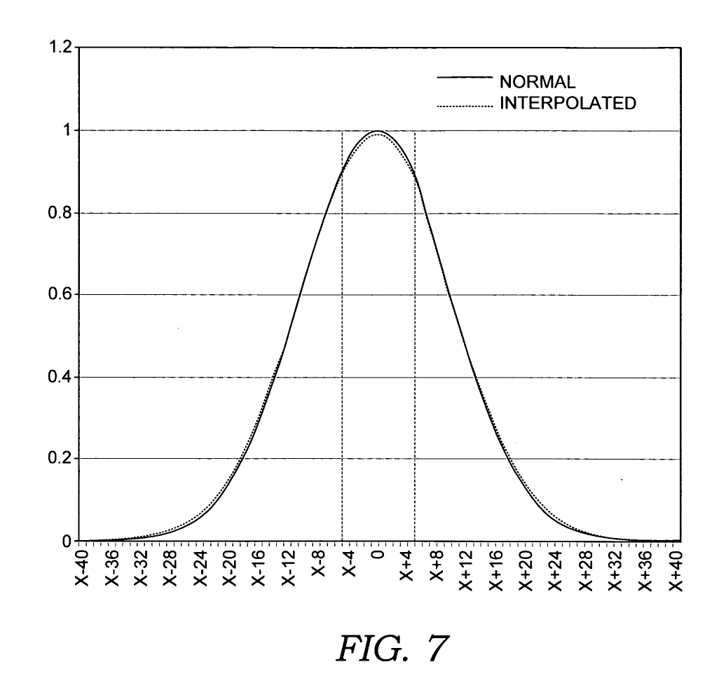

FIG. 6 is a flow chart illustrating a method for applying a blur to an image in an embodiment of the present invention. As illustrated in FIG. 6, method 600 begins at operation 604, where a vertex shader module in a GPU is instructed to scale the image down. At operation 606, a pixel shader module in the GPU is instructed to perform a blur. At operation 608, the vertex shader module is instructed to return the image to original size (scale the image up).

The hardware included in the system may include memories, processors, and/or Application Specific Integrated Circuits (“ASICs”). Such memory may include a machine-readable medium on which is stored a set of instructions (i.e. software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for applying a blur to an image using a graphic processing unit, the method comprising:
instructing the graphic processing unit to scale the image down from an original size;
instructing the graphic processing unit to blur the scaled down image; and
instructing the graphic processing unit to return the blurred scaled down image to the original size.

2. The method of claim 1, wherein the scaling of the image down from the original size is performed by a vertex shader module.

3. The method of claim 1, wherein the blurring of the scaled down image is performed by a pixel shader module.

4. The method of claim 1, wherein the returning of the blurred scaled down image to the original size is performed by a vertex shader module.

5. The method of claim 1, wherein the blur is a Gaussian Blur.

6. The method of claim 1, wherein the blur is performed according to a predetermined radius.

7. The method of claim 6, wherein the predetermined radius is measured in pixels.

8. The method of claim 1 further comprising:
presenting the blurred original size image to a user.

9. A computer-readable medium having computer-executable instructions for performing the method recited in claim 1.

10. A method for applying a blur to an image using a graphic processing unit, the method comprising:
instructing the graphic processing unit to scale the image down from an original size;
instructing the graphic processing unit to blur the scaled down image, wherein the blur is performed according to a predetermined radius that is measured in pixels; and
instructing the graphic processing unit to return the blurred scaled down image to the original size.

11. The method of claim 10, wherein the scaling of the image down from the original size is performed by a vertex shader module.

12. The method of claim 10, wherein the blurring of the scaled down image is performed by a pixel shader module.

13. The method of claim 10, wherein the returning of the blurred scaled down image to the original size is performed by a vertex shader module.

14. The method of claim 10, wherein the blur is a Gaussian Blur.

15. The method of claim 10 further comprising:
presenting the blurred original size image to a user.

16. A computer-readable medium having computer-executable instructions for performing the method recited in claim 10.

17. A method for applying a Gaussian Blur to an image using a graphic processing unit, the method comprising:
instructing the graphic processing unit to scale the image down from an original size using a vertex shader module;
instructing the graphic processing unit to blur the scaled down image using a pixel shader module, wherein the blur is performed according to a predetermined radius that is measured in pixels;
instructing the graphic processing unit to return the blurred scaled down image to the original size using the vertex shader module; and
presenting the blurred original size image to a user.

18. A computer-readable medium having computer-executable instructions for performing the method recited in claim 17.
